(19) United States
(12) Patent Application Publication
(10) Pub. No.: US 2023/0007557 A1
(43) Pub. Date: Jan. 5, 2023

(54) METHOD AND APPARATUS FOR HANDOVER

(71) Applicant: Telefonaktiebolaget LM Ericsson (publ), Stockholm (SE)

(72) Inventors: Jinyin ZHU, Shanghai (CN); Peter HEDMAN, Helsingborg (SE); Gunnar MILDH, Sollentuna (SE)

(21) Appl. No.: 17/778,980

(22) PCT Filed: Nov. 24, 2020
(86) PCT No.: PCT/CN2020/131161

§ 371 Date: May 23, 2022

(30) Foreign Application Priority Data
Nov. 25, 2019 (CN) PCT/CN2019/120606

(51) Int. Cl. H04W 36/12; H04L 65/1016

(52) U.S. Cl. CPC H04W 36/125; H04L 65/1016

(57) ABSTRACT

Embodiments of the present disclosure provide methods and apparatuses for handover. A method performed by a source NG-RAN, base station in a wireless communication network, for handling handover of a User Equipment, UE, in which the method includes obtaining an indication information which indicates the IP Multimedia Subsystem, IMS, voice call initiation. The method further includes performing a handover policy to prioritize handover or redirection to an Evolved-Universal Terrestrial Radio Access Network, E-UTRAN, base station over handover to a target NG-RAN base station.

### TECHNICAL FIELD

The non-limiting and exemplary embodiments of the present disclosure generally relate to the technical field of communications, and specifically to methods and apparatuses for handover handling.

### BACKGROUND

This section introduces aspects that may facilitate a better understanding of the disclosure. Accordingly, the statements of this section are to be read in this light and are not to be understood as admissions about what is in the prior art or what is not in the prior art.

FIG. 1 schematically shows a high level architecture in the next generation network such as 5G. The system architecture of FIG. 1 may comprise some exemplary elements such as UE (User Equipment), AMF (Access and mobility Function), SMF (Session Management Function), AUSF (Authentication Service Function), UDM (Unified Data Management), PCF (Policy Control Function), AF (Application Function), NSSF (Network Slice Selection Function), NEF (Network Exposure Function), UPF (User plane Function) and NRF (NF Repository Function), (R)AN ((Radio) Access Network), SCP (Service Communication Proxy), DN (Data Network), etc.

In accordance with an exemplary embodiment, the UE can establish a signaling connection with the AMF over the reference point N1, as illustrated in FIG. 2. This signaling connection may enable NAS (Non-access stratum) signaling exchange between the UE and the core network, comprising a signaling connection between the UE and the (R)AN and the N2 connection for this UE between the (R)AN and the AMF. The (R)AN can communicate with the UPF over the reference point N3. The UE can establish a packet data unit (PDU) session to the DN (data network, e.g. an operator network or Internet) through the UPF over the reference point N6.

As further illustrated in FIG. 1, the exemplary system architecture also contains the service-based interfaces such as Nnrf, Nnef, Nausf, Nudm, Npcf, Namf and Nsmf exhibited by NFs such as the NRF, the NEF, the AUSF, the UDM, the PCF, the AMF and the SMF. In addition, FIG. 1 also shows some reference points such as N1, N2, N3, N4, N6 and N9, which can support the interactions between NF services in the NFs. For example, these reference points may be realized through corresponding NF service-based interfaces and by specifying some NF service consumers and providers as well as their interactions in order to perform a particular system procedure.

As 3GPP TS23.501 V16.2.0 section 5.16.3.10 describes: in order to support various deployment scenarios for obtaining IMS (IP Multimedia Subsystem) voice service, the UE and NG-RAN(Next Generation-Radio Access Network) may support the mechanism to direct or redirect the UE from NG-RAN either towards E-UTRA (Evolved-Universal Terrestrial Radio Access) connected to 5GC (5G Core Network, RAT fallback) or towards EPS (Evolved Packet System, E-UTRAN (Evolved-Universal Terrestrial Radio Access Network) connected to EPC System fallback). And 3GPP TS23.502 V16.2.0 section 4.13.6 further describes the detailed procedure of EPS fallback for IMS voice and Inter RAT fallback in 5GC for IMS voice, the disclosure of which is incorporated by reference herein in its entirety.

3GPP TS23.502 V16.2.0 section 4.9.1 describes the handover procedure from a source NG-RAN node to a target NG-RAN node using the Xn or N2 reference points in 3GPP access, the disclosure of which is incorporated by reference herein in its entirety. When a handover procedure is ongoing, NG-RAN shall reject any N2 quest other than that for handover procedure and the AMF or SMF shall wait for the completeness of the handover procedure to reinitiate the request to NG-RAN again.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

When EPS fallback or inter RAT fallback applies for the UE and a MO (Mobile Originate)/MT (Mobile Terminate) call is initiated, there is the possibility that a normal intra NR (New Radio) handover procedure, e.g., Xn based handover or N2 based handover, takes place immediately after it which moves the UE to a target NR. Then after the normal handover procedures concludes, upon receiving the request for voice QoS flows setup, the target NR will trigger handover or redirection procedure to move the UE to target EPS or target E-UTRA connected to 5GC. In this case, the problem is that the normal intra NR handover is useless and the IMS voice call setup time is increased much.

To overcome or mitigate at least one above mentioned problems or other problems or provide a useful solution, the embodiments of the present disclosure propose an improved context resume solution.

According to a first aspect of the disclosure, there is provided a method in a source Next Generation-Radio Access Network, NG-RAN, base station in a wireless communication network, for handling handover of a User Equipment, UE. The method comprises obtaining an indication information which indicates the IP Multimedia Subsystem, IMS, voice call initiation. The method further comprises performing a handover policy to prioritize handover or redirection to an Evolved-Universal Terrestrial Radio Access Network, E-UTRAN, base station over handover to a target NG-RAN base station.

In an embodiment of the disclosure, the obtaining an indication information which indicates the IMS voice call initiation comprises determining the indication information by the source NG-RAN base station based on a message received from the UE.

In an embodiment of the disclosure, the obtaining an indication information which indicates the IMS voice call initiation comprises receiving the indication information from the UE.

In an embodiment of the disclosure, the obtaining an indication information which indicates the IMS voice call initiation comprises receiving the indication information from another network entity.

In an embodiment of the disclosure, the obtaining an indication information which indicates the IMS voice call initiation comprises determining the indication information by the source NG-RAN base station based on a message received from another network entity.

In an embodiment of the disclosure, the another network entity comprises User Plane Function, UPF, or Access Management Function, AMF.

In an embodiment of the disclosure, the method further comprises triggering the UE for measurement report of neighboring cells.

In an embodiment of the disclosure, the E-UTRAN base station is a base station in Evolved Packet System, EPS, or a base station in Evolved-Universal Terrestrial Radio Access, E-UTRA, connected to 5G Core network.

According to a second aspect of the disclosure, there is provided a method at a first network entity in a wireless communication network, for handling handover of a User Equipment, UE. The method comprises determining an indication information which indicates the IP Multimedia Subsystem, IMS, voice call initiation. The method further comprises sending the indication information to a second network entity.

In an embodiment of the disclosure, the first network entity is User Plane Function, UPF, the second network entity is a Next Generation-Radio Access Network, NG-RAN, base station or a Session Management Function, SMF.

In an embodiment of the disclosure, the method further comprises receiving a request for the indication information from the SMF.

In an embodiment of the disclosure, the first network entity is P-CSCF (Proxy-Call Session Control Function), the second network entity is AMF or SMF.

In an embodiment of the disclosure, the method further comprises receiving subscription for events for IMS voice call initiation from AMF or SMF.

According to a third aspect of the disclosure, there is provided an apparatus at source Next Generation-Radio Access Network, NG-RAN, base station, the apparatus comprising a processor; and a memory coupled to the processor, the memory containing instructions executable by said processor, the apparatus is operative to obtain an indication information which indicates the IP Multimedia Subsystem, IMS, voice call initiation. The apparatus is operative to perform a handover policy to prioritize handover or redirection to an Evolved-Universal Terrestrial Radio Access Network, E-UTRAN, base station over handover to a target NG-RAN base station.

In an embodiment of the disclosure, the apparatus is operative to perform the method according to the above first aspect.

According to a fourth aspect of the disclosure, there is provided an apparatus at a first network entity. The apparatus comprises a processor; and a memory coupled to the processor, the memory containing instructions executable by said processor, the apparatus is operative to determine an indication information which indicates the IP Multimedia Subsystem, IMS, voice call initiation. The apparatus is further operative to send the indication information to a second network entity.

In an embodiment of the disclosure, the apparatus is operative to perform the method according to the above second aspect.

Many advantages may be achieved by applying the proposed solution according to embodiments of the present disclosure. For example, this solution can reduce the IMS voice call setup time and avoid the unnecessary intra-NR handover procedure when IMS voice call is initiated.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 schematically shows a high level architecture in the 5G network;

FIG. 2 schematically shows a flow chart of the prior art;

FIG. 3 shows a flowchart of a method according to one embodiment of the present disclosure;

FIG. 4 shows a flowchart of a method according to one embodiment of the present disclosure;

FIG. 5 shows a flowchart of a method according to another embodiment of the present disclosure;

FIG. 6 shows a flowchart of a method according to another embodiment of the present disclosure;

FIG. 7 shows a flowchart of a method according to another embodiment of the present disclosure;

FIG. 8 shows a flowchart of a method according to another embodiment of the present disclosure;

FIG. 9 shows a flowchart of a method according to another embodiment of the present disclosure;

FIG. 10 is a block diagram showing an apparatus suitable for use in practicing some embodiments of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR). In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols as may comprise the 5G communication protocols, and/or any other protocols either currently known or to be developed in the future.

The term “network entity” can be implemented in a physical network node, or in a virtual network node which perform a function by logical resources in more than one physical network node. The “network entity” can be implemented in a centralized way, or in a distributed way. The “network entity” can also be implemented in the cloud.

The term “network function (NF)” refers to any suitable function which can be implemented in a network node (physical or virtual) of a communication network. For example, the 5G system (5GS) may comprise a plurality of NFs such as AMF, SMF, AUSF, UDM, PCF, AF, NEF, UPF and NRF, (R)AN, SCP, etc. In other embodiments, the network function may comprise different types of NFs for example depending on a specific type of network.

The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP, such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

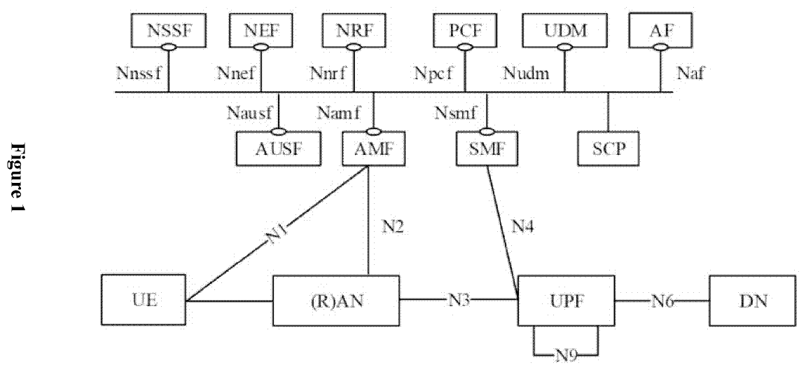

Although the subject matter described herein may be implemented in any appropriate type of system using any suitable components, the embodiments disclosed herein are described in relation to a communication system complied with the exemplary system architecture illustrated in FIG. 1. For simplicity, the system architecture of FIG. 1 only depicts some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

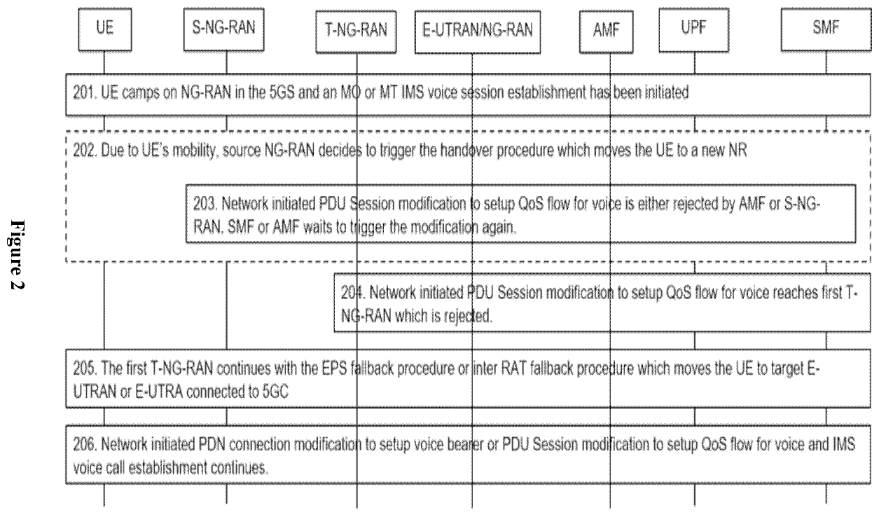

FIG. 2 shows a procedure of IMS voice call setup coinciding with intra-NR handover procedure according to the prior art.

At step 201, UE camps on NG-RAN in the 5GS and an MO or MT IMS voice session establishment has been initiated, i.e., UE has sent SIP Invite message to network or has received SIP Invite message from network.

At step 202, due to UE's mobility, source NG-RAN (NR in this case) decides to trigger the handover procedure which moves the UE to a new NG-RAN (NR in this case).

At step 203, during the handover procedure, network initiated PDU Session modification to setup QoS flow for voice is either rejected by AMF (N2 based handover) or S-NG-RAN (Xn based handover or N2 based handover). SMF or AMF holds the request and reinvokes it after conclusion of the handover or expiry of a locally configured timer.

At step 204, after the handover procedure completes, SMF or AMF reinvokes the PDU Session modification to setup QoS (Quality of Service) flow for voice and this is rejected by the target NG-RAN.

At step 205, the target NG-RAN continues with the EPS fallback procedure or inter RAT fallback procedure which moves the UE to target E-UTRAN or E-UTRA connected to 5GC.

At step 206, network initiated PDN (Packet Data Network) connection modification to setup voice bearer or PDU Session modification to setup QoS flow for voice and IMS voice call establishment continues.

According to the procedure above, when IMS voice call setup coincides with intra-NR handover procedure, SMF or AMF has to wait until the intra-NR handover ends, and then trigger the modification again to setup QoS flow for voice.

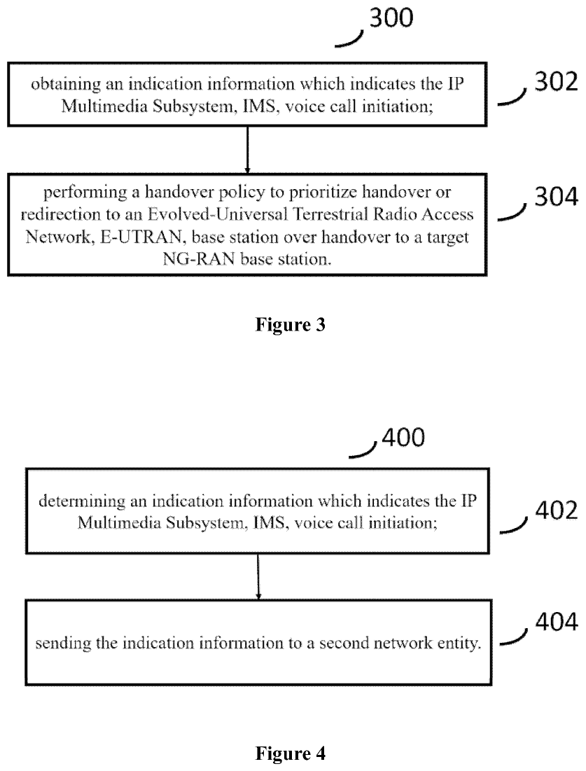

FIG. 3 shows a flowchart of a method according to an embodiment of the present disclosure, which may be performed by an apparatus implemented in or at or communicatively coupled to a NG-RAN base station. As such, the apparatus may provide means or module for accomplishing various parts of the method 300 as well as means or module for accomplishing other processes in conjunction with other components.

The present solution is to have NR (NG-RAN) be aware of the IMS voice call initiation so that in case of EPS fallback or inter RAT fallback being applicable, NR will change the handover policy to prioritize handover/redirection to EPS or E-UTRA connected to 5GC. When NR is aware of IMS voice call initiation, NR can also solicitate the measurement report from UE for the neighboring E-UTRA cells.

As used herein, the NR-RAN base station may be gNB (Next generation NodeB) in 5G.

At block 302, NR-RAN base station may obtain an indication information which indicates the IP Multimedia Subsystem, IMS, voice call initiation.

The NR can get ware of the IMS voice call initiation through this step. Before this step, the UE already camps on NG-RAN in 5GS (5G System). And there are various ways to have NR aware of the IMS voice call initiation.

In one embodiment, the source NG-RAN base station can determine the indication information by itself. For example, for MO call, when UE initiates IMS voice call during IDLE status and sets the RRC establishment cause to be “mo-VoiceCall”, and upon receiving the RRC message, the NG-RAN base station detects the cause is “mo-VoiceCall”, it decides that the IMS voice call is initiated. In another example, the source NG-RAN base station can perform packet inspection or classification to check whether SIP Invite is received. For example, when NG-RAN base station receives the uplink data (e.g., from UE) or downlink data (e.g., form UPF), it will perform the inspection/classification for packets of specific QoS flows, e.g., QoS flow with 5QI=5. When NG-RAN base station performs the classification, it will classify the data into different categories. If the data is classified as a “SIP INVITE” category, NG-RAN knows that IMS voice call is initiated. The classification may be implemented by deriving the actual SIP message content, or by separating “SIP INVITE” from other SIP messages e.g. by the size of the massages.

In another embodiment, the NG-RAN base station doesn't determine the indication information which indicates the IMS voice call initiation by itself, it receives the indication information directly from the UE. In this embodiment, the UE additionally indicates the IMS voice call initiation in a message. For example, UE adds the indication information in SDAP (Service Data Adaptation Protocol) header or PDCP (Packet Data Convergence Protocol) header. If SDP (Session Description Protocol) header is applicable for the radio bearer associated with IMS signaling QoS flow (e.g., QoS flow with 5QI=5), when UE sends SIP INVITE (for MO call) or 183 SDP (for MT call), UE additionally indicates the IMS voice call initiation in SDAP header; if SDP header is not applicable, UE will additionally indicate the IMS voice call initiation in PDCP header.

In another embodiment, the NG-RAN base station doesn't determine the indication information which indicates the IMS voice call initiation by itself, it receives the indication information directly from the UPF. In this embodiment, the UPF additionally indicates the IMS voice call initiation in a message. There are various ways for UPF about how to obtain the indication information. In one embodiment, UPF performs packet inspection/classification to check whether SIP Invite is received. The inspection/classification is performed for packets of specific QoS flows, e.g., QoS flow with 5QI=5. The packet inspection/classification may be done according the request from another network entity, e.g., SMF. Alternatively, an agreed packet marking from IMS is used, for example, using a dedicated DSCP (Differentiated Services Code Point) for SIP messages that are for signalling and to be prioritized for handover e.g. SIP INVITE.

In another embodiment, the NG-RAN base station doesn't determine the indication information which indicates the IMS voice call initiation by itself, it receives the indication information directly from the AMF. In this embodiment, the AMF receives the indication information form another network entity. In one example, the AMF receives the indication information from SMF; in another example, the AMF receives the indication information from P-CSCF.

In the scenario that AMF receives the indication information from P-CSCF: the AMF may make a subscription for receiving EventExposure events for indication information which indicates the IMS voice call initiation from P-CSCF, and as P-CSCF knows the indication information, P-CSCF sends the indication information to the AMF. And then AMF sends the N2 request to NG-RAN base station including the indication information.

In the scenario that AMF receives the indication information from SMF. The SMF will get the indication information in various ways. In one example, the SMF may make a subscription for receiving EventExposure events for indication information which indicates the IMS voice call initiation from P-CSCF, and as P-CSCF knows the indication information, P-CSCF will send the indication information to the SMF. In another example, the SMF installs rules for enabling the UPF to perform inspection/classification to get the indication information, the UPF will perform inspection/classification to get the indication information as described above, and then UPF will send a report message including the indication information to the SMF.

At block 304, NG-RAN base station performs a handover policy to prioritize handover or redirection to an Evolved-Universal Terrestrial Radio Access Network, E-UTRAN, base station over handover to a target NG-RAN base station.

When NG-RAN base station is aware that IMS voice call is initiated form the indication information, if there is a handover to a new target NG-RAN base station is ongoing, the NG-RAN base station (herein the source NG-RAN base station) may react to the indication information in two ways: firstly, if the ongoing handover to a new target NG-RAN base station is in preparation phase (e.g., handover command is not sent to UE yet), the source NG-RAN base station may decide to cancel the ongoing handover procedure and prepare for handover or redirection to target E-UTRAN base station; secondly, if the ongoing handover to the new target NG-RAN base station is already in execution phase (e.g., the handover command is already sent to UE), then source NG-RAN base station may decide to continue the ongoing handover procedure to the new target NG-RAN base station.

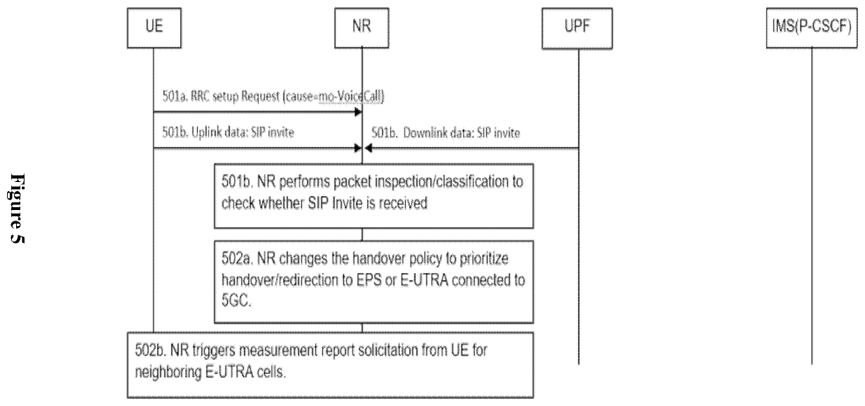

FIG. 4 shows a flowchart of a method according to an embodiment of the present disclosure, which may be performed by an apparatus implemented in or at a first network entity or communicatively coupled to a first network entity. As such, the apparatus may provide means or module for accomplishing various parts of the method 400 as well as means or module for accomplishing other processes in conjunction with other components.

In one embodiment, the first network entity is UPF. In another embodiment, the first network entity is P-CSCF.

In the scenario that the first network entity is UPF, the flow chart is as below:

At step 502, the UPF determines an indication information which indicates the IP Multimedia Subsystem, IMS, voice call initiation. The UPF may determine the indication information in various ways. In one example, the UPF may perform the packet inspection to check whether SIP INVITE is received. The packet inspection is performed for packets of specific QoS flows, e.g., QoS flow with 5QI=5. In another example, the UPF may perform the packet classification to check whether SIP INVITE is received. The packet classification may include deriving the actual SIP message content or separating SIP INVITE from other SIP messages by size or by other parameters.

Before step 502, the SMF may send the request for determining the indication information to the UPF, or SMF may install rules for enabling the UPF to perform the inspection or classification for the indication information. And then the UPF determines the indication information according to the request from the SMF or based on the rules installed.

At step 504, the UPF sends the indication information to NG-RAN base station directly, or UPF sends the indication information to the SMF, and then SMF sends the indication information to the NG-RAN base station.

After the NG-RAN base station receives the indication information, it may react to the indication information in different ways as described above, herein is omitted for brief.

In the scenario that the first network entity is P-CSCF, the flow chart is as below:

At step 502, the P-CSCF determines an indication information which indicates the IP Multimedia Subsystem, IMS, voice call initiation. The UPF may determine the indication information in various ways as UPF does above.

Before step 502, the P-CSCF may receive the subscription for receiving EventExposure events for indication information which indicates the IMS voice call initiation from AMF or SMF. After receiving the subscription, the P-CSCF determines an indication information.

At step 504, the P-CSCF may send the indication information to AMF directly, or UPF sends the indication information to the SMF, and then SMF sends the indication information to the AMF. After AMF receives the indication information, it sends the indication information to NG-RAN base station.

After the NG-RAN base station receives the indication information, it may react to the indication information in different ways as described above, herein is omitted for brief.

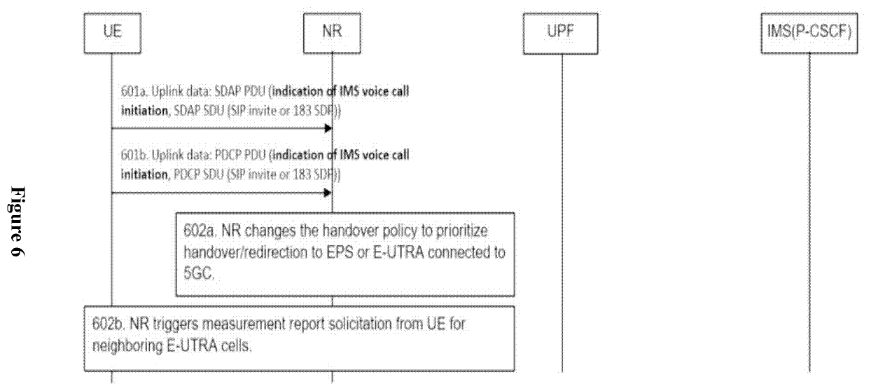

FIG. 5 show a flowchart of a method according to an embodiment of the present disclosure. The NR (for example: NG-RAN base station) do packet inspection/classification by itself (e.g., for packets of 5QI=5 QoS flow) to check whether an “SIP invite” has been received from UE or UPF (e.g. a SIP INVITE may be possible to distinguish from size without the need to decrypt the actual message). For MO voice call, another option for NR to be aware of this is based on RRC establishment cause “mo-VoiceCall” if previously received.

Step 501a, 1a. for MO call, when UE initiates IMS voice call during IDLE status and sets the RRC establishment cause to be “mo-VoiceCall”. By this NR decides that the IMS voice call is initiated.

Step 501b, when NR receives uplink data or downlink data, NR performs packet inspection/classification to check whether SIP Invite is received. The inspection/classification is performed for packets of specific QoS flows, e.g., QoS flow with 5QI=5. If data is received which NR classifies as a SIP Invite, NR decides that IMS voice call is initiated. The classification may include deriving the actual SIP message content or to be able to separate SIP INVITEs from other SIP messages e.g. by size.

Step 502a, NR changes the handover policy to prioritize handover/redirection to EPS or E-UTRA connected to 5GC over intra-NR handover.

Step 502b, NR triggers measurement report solicitation from UE for neighboring E-UTRA cells.

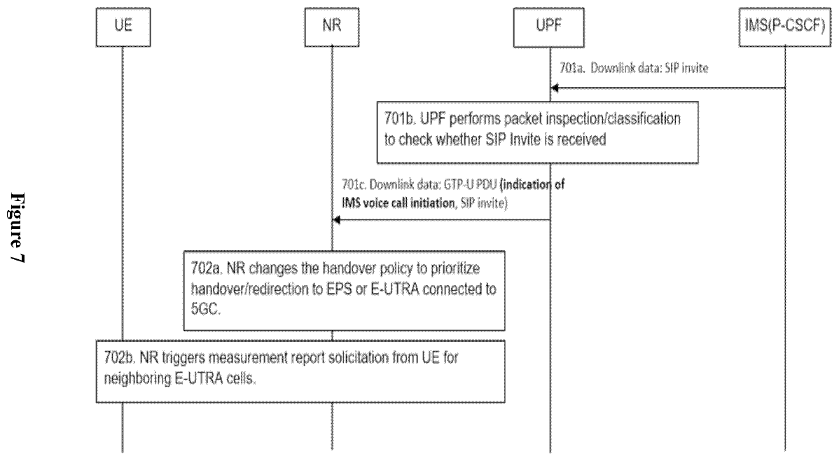

FIG. 6 show a flowchart of a method according to an embodiment of the present disclosure. In this procedure, UE provides additional IMS voice call indication to NR together with the packet carrying SIP INVITE message (for MO call) or 183 SDP response message (for MT call). The indication can be carried in, e.g., SDAP header or PDCP header.

Step 601a, if SDP header is applicable for the radio bearer associated with IMS signaling QoS flow (e.g., QoS flow with 5QI=5), when UE sends SIP invite (for MO call) or 183 SDP (for MT call), UE additionally indicates the IMS voice call initiation in SDAP header.

Step 601b, if SDP header is not applicable for the radio bearer associated with IMS signaling QoS flow (e.g., QoS flow with 5QI=5), when UE sends SIP invite (for MO call) or 183 SDP (for MT call), UE additionally indicates the IMS voice call initiation in PDCP header.

The step 602a and 602b are the same as step 502a and 502b in FIG. 5, its details are omitted here.

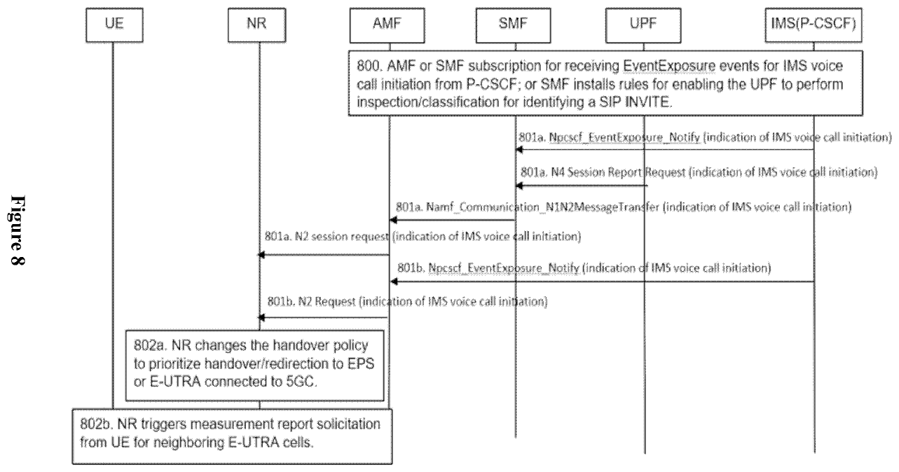

FIG. 7 show a flowchart of a method according to an embodiment of the present disclosure. In this procedure, UPF do packet inspection/classification (e.g., for packets of 5QI=5 QoS flow) to check whether an “SIP invite” has been received from core side and provides additional IMS voice call indication to NR together with the packet carrying SIP Invite message. The indication can be carried in, e.g., GTP-U extension header.

Step 701a. UPF receives downlink data from core network side.

Step 701b. UPF performs packet inspection/classification to check whether SIP Invite is received. The inspection/classification is performed for packets of specific QoS flows, e.g., QoS flow with 5QI=5. The packet inspection/classification may be done according the request from SMF. Alternatively, an agreed packet marking from IMS is used e.g. using a dedicated DSCP for SIP messages that are for signaling and to be prioritized for handover e.g. SIP INVITE.

Step 701c. if SIP invite is received, UPF additionally indicates the IMS voice call initiation to NR. The indication can be carried in GTP-U extension header. Adding this indication may be done according to request from SMF over N4.

The step 702a and 702b are the same as step 502a and 502b in FIG. 5, its details are omitted here.

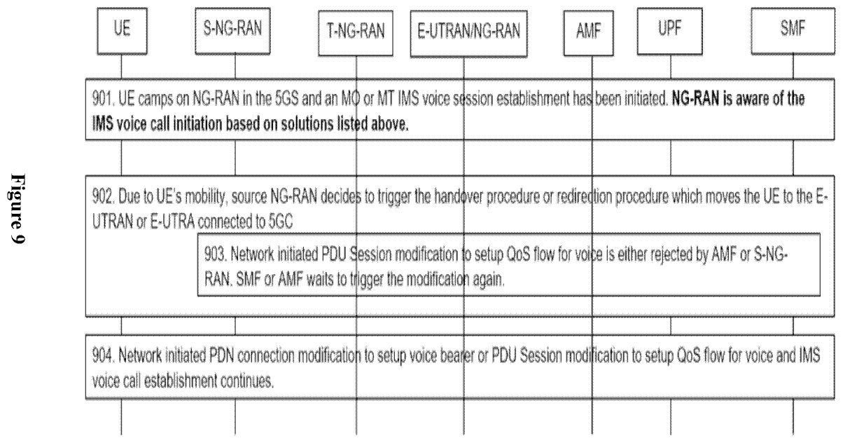

FIG. 8 show a flowchart of a method according to an embodiment of the present disclosure. In this procedure, SMF or AMF provides IMS voice call indication to NR based on the notification from P-CSCF or UPF. In this case, AMF or SMF can subscribe the IMS voice call initiation from P-CSCF, or the SMF can request UPF to report the detection of IMS voice call initiation.

Step 800. AMF or SMF may subscribe from P-CSCF for receiving EventExposure events for IMS voice call initiation; or as another option, SMF installs rules for enabling the UPF to perform inspection/classification for identifying a SIP INVITE.

Step 801a. P-CSCF sends a notification to SMF indicating the IMS voice call initiation.

Another option is that UPF sends a report message to SMF indicating the IMS voice call initiation. UPF knows the IMS voice call initiation based on packet inspection/classification as described in FIG. 7.

After SMF received the notification indicating the IMS voice call initiation, the SMF sends a message Namf_Communication_N1N2MessageTransfer to AMF and AMF sends the N2 session request to NR. In the messages, indication of IMS voice call initiation is included.

Step 801b. P-CSCF sends a notification to AMF indicating the IMS voice call initiation. Then AMF sends the N2 request to NR and in the message, indication of IMS voice call initiation is included.

The step 802a and 802b are the same as step 502a and 502b in FIG. 5, its details are omitted here.

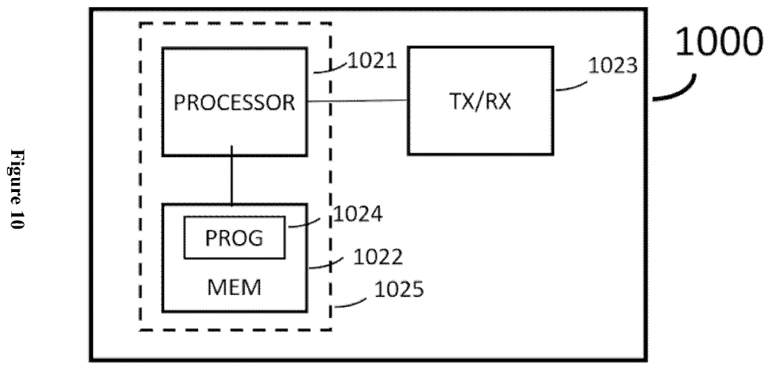

FIG. 9 shows the improved procedure of IMS voice call setup coinciding with UE mobility procedure.

Step 901, UE camps on NG-RAN in the 5GS and an MO or MT IMS voice session establishment has been initiated. NG-RAN is aware of the IMS voice call initiation based on solutions listed above.

Step 902, due to UE's mobility, source NG-RAN decides to trigger the handover procedure or redirection procedure which moves the UE to the E-UTRAN or E-UTRA connected to 5GC.

Step 903, Network initiated PDU Session modification to setup QoS flow for voice is either rejected by AMF or S-NG-RAN. SMF or AMF waits to trigger the modification again.

Step 904, Network initiated PDN connection modification to setup voice bearer or PDU Session modification to setup QoS flow for voice and IMS voice call establishment continues.

Therefore, it can be seen that this solution can reduce the IMS voice call setup time and avoid the unnecessary intra-NR handover procedure when IMS voice call is initiated.

The apparatus 1000 comprises at least one processor 1021, such as a DP, and at least one MEM 1022 coupled to the processor 1021. The apparatus 1000 may further comprise a transmitter TX and receiver RX 1023 coupled to the processor 1021. The MEM 1022 stores a PROG 1024. The PROG 1024 may include instructions that, when executed on the associated processor 1021, enable the apparatus 1020 to operate in accordance with the embodiments of the present disclosure. A combination of the at least one processor 1021 and the at least one MEM 1022 may form processing means 1025 adapted to implement various embodiments of the present disclosure.

Various embodiments of the present disclosure may be implemented by computer program executable by one or more of the processor 1021, software, firmware, hardware or in a combination thereof.

The MEM 1022 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 1021 may be of any type suitable to the local technical environment, and may include one or more of general purpose computers, special purpose computers, microprocessors, digital signal processors DSPs and processors based on multicore processor architecture, as non-limiting examples.

According to an aspect of the disclosure it is provided a computer program product being tangibly stored on a computer readable storage medium and including instructions which, when executed on at least one processor, cause the at least one processor to carry out any of the methods related to the NG-RAN base station above.

According to an aspect of the disclosure it is provided a computer program product being tangibly stored on a computer readable storage medium and including instructions which, when executed on at least one processor, cause the at least one processor to carry out any of the methods related to the first network entity as described above.

According to an aspect of the disclosure it is provided a computer-readable storage medium storing instructions which when executed by at least one processor, cause the at least one processor to carry out any of the methods related to the NG-RAN base station as described above.

According to an aspect of the disclosure it is provided a computer-readable storage medium storing instructions which when executed by at least one processor, cause the at least one processor to carry out any of the methods related to the first network entity as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform one or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method at a source Next Generation-Radio Access Network, NG-RAN, base station in a wireless communication network, for handling handover of a User Equipment, UE, the method comprising:
obtaining an indication information which indicates the IP Multimedia Subsystem, IMS, voice call initiation; and
performing a handover policy to prioritize one of handover and redirection to an Evolved-Universal Terrestrial Radio Access Network, E-UTRAN, base station over handover to a target NG-RAN base station.

2. The method according to claim 1, wherein the obtaining an indication information which indicates the IMS voice call initiation comprises:
determining the indication information by the source NG-RAN base station based on a message received from the UE.

3. The method according to claim 1, wherein the obtaining an indication information which indicates the IMS voice call initiation comprises:
receiving the indication information from the UE.

4. The method according to claim 1, wherein the obtaining an indication information which indicates the IMS voice call initiation comprises:
receiving the indication information from another network entity.

5. The method according to claim 1, wherein the obtaining an indication information which indicates the IMS voice call initiation comprises:
determining the indication information by the source NG-RAN base station based on a message received from another network entity.

6. The method according to claim 4, wherein the another network entity comprises:
User Plane Function, UPF, or Access Management Function, AMF.

7. The method according to claim 1, the method further comprises:
triggering the UE for measurement report of neighboring cells.

8. The method according to claim 1, wherein the E-UTRAN base station is one of a base station in Evolved Packet System, EPS, and a base station in Evolved-Universal Terrestrial Radio Access, E-UTRA, connected to 5G Core network.

9. A method at a first network entity in a wireless communication network, for handling handover of a User Equipment, UE, the method comprising:
determining an indication information which indicates the IP Multimedia Subsystem, IMS, voice call initiation;
sending the indication information to a second network entity.

10. The method according to claim 9, wherein the first network entity is User Plane Function, UPF, and the second network entity is one of a Next Generation-Radio Access Network, NG-RAN, base station and a Session Management Function, SMF.

11. The method according to claim 10, wherein the method further comprises:
receiving a request for the indication information from the SMF.

12. The method according to claim 9, wherein the first network entity is Proxy-Call Session Control Function, P-CSCF, and the second network entity is one of AMF and SMF.

13. The method according to claim 12, wherein the method further comprises:
receiving subscription for events for IMS voice call initiation from one of AMF and SMF.

14. An apparatus at source Next Generation-Radio Access Network, NG-RAN, base station, comprising:
a processor; and
a memory coupled to the processor, the memory containing instructions executable by said processor, to configure the apparatus to:
obtain an indication information which indicates the IP Multimedia Subsystem, IMS, voice call initiation; and
perform a handover policy to prioritize one of handover and redirection to an Evolved-Universal Terrestrial Radio Access Network, E-UTRAN, base station over handover to a target NG-RAN base station.

15. The apparatus according to claim 14, wherein obtaining an indication information which indicates the IMS voice call initiation comprises:
determining the indication information by the source NG-RAN base station based on a message received from the UE.

16. An apparatus at a first network entity, comprising:
a processor; and
a memory coupled to the processor, the memory containing instructions executable by said processor, to configure the apparatus to:
determine an indication information which indicates the IP Multimedia Subsystem, IMS, voice call initiation; and
send the indication information to a second network entity.

17. The apparatus according to claim 16, wherein the first network entity is User Plane Function, UPF, and the second network entity is one of a Next Generation-Radio Access Network, NG-RAN, base station and a Session Management Function, SMF.

18. The apparatus according to claim 10, wherein obtaining an indication information which indicates the IMS voice call initiation comprises:
receiving the indication information from the UE.

19. The apparatus according to claim 10, wherein obtaining an indication information which indicates the IMS voice call initiation comprises:
receiving the indication information from another network entity.

20. The apparatus according to claim 10, wherein the obtaining an indication information which indicates the IMS voice call initiation comprises:
determining the indication information by the source NG-RAN base station based on a message received from another network entity.
